(19) United States
(12) Patent Application Publication
(10) Pub. No.: US 2015/0355354 A1
(43) Pub. Date: Dec. 10, 2015

(54) METHOD OF ANALYZING SEISMIC DATA

(71) Applicant: WESTERNGECO LLC, Houston, TX (US)

(72) Inventor: Michael John Williams, Cambridge (GB)

(21) Appl. No.: 14/760,759

(22) PCT Filed: Jan. 14, 2014
(86) PCT No.: PCT/US2014/011383

§ 371 Date: Jul. 14, 2015

Related U.S. Application Data
(60) Provisional application No. 61/752,027, filed on Jan. 14, 2013.

(51) Int. Cl. G01V 1/28; G01V 1/30

(52) U.S. Cl. CPC G01V 1/288; G01V 1/30; G01V 1/282; G01V 2210/65; G01V 2210/1234

(57) ABSTRACT

A method of analyzing measured microseismic events obtained from monitoring induced hydraulic fracturing of underground geological formations, the method involving (a) postulating the location of an evolving planar fracture, having a temporal and spatial trajectory based on a fracture propagation model requiring knowledge of the material properties of the geology, an initiation point and at least two measured microseismic events that fit the postulated fracture trajectory; (b) assessing whether additional measured microseismic events are sufficiently close to the temporal and spatial trajectory to be considered to be occurring as part of the propagation of the fracture; (c) determining whether the postulated fracture trajectory is statistically significant by comparing the number of microseismic events which are sufficiently close with a statistical baseline number; (d) repeating steps (a) to (c) as necessary until at least one plausible fracture plane consistent with the measured events is found is provided.

### BACKGROUND

Embodiments of the present invention relate to methods of analyzing microseismic data obtained from monitoring induced hydraulic fracturing of underground oilfield geological formations.

Hydraulic fracture monitoring (“HFM”) is employed in underground oil and gas wellbores to provide, among other things, an understanding of the geometry of hydraulic fractures to enable better completion design, reliable production predictions, and real-time operational decisions during the treatment itself.

Hydraulic fracturing involves the injection of a fluid into a geological formation with the intention of initiating fracture in the formation. Such fractures tend to propagate in a vertical plane, due to the arrangement of stresses in such underground locations. The interaction of the fluid with the formation may induce propagation of a fracture in the formation giving rise to microseismic activity. However measured microseismic data may include a large degree of scatter and uncertainty as to the precise spatial location of the microseismic event(s) generating the measured data.

Additionally, noise and microseismic data may be measured that is unrelated to the propagation/generation of a fracture, and may relate to other geological processes, which may or may not be associated with the fracture propagation/generation. The scatter and/or noise in such measured data may be so great that it may not be possible to find best-fit planes within the data to postulate the presence of an actual fracture location.

Thus, assumptions may have to be made in order to be able to perform such fracture location postulations. A first assumption may be that the fracture plane has a vertical component and furthermore the orientation in the vertical plane may be assumed. Thus, armed with the assumption that the fracture planes may be NW or SE vertical fracture planes, for example, best fit fracture planes can be postulated. However the shortcomings of this approach are clear. Particularly the fact that it relies on a knowledge of the location of fracture plan alignment, which may not be possible to know.

Previous studies have examined a link between fracture propagation and microseismicity. Fischer et al. (Microseismic signatures of hydraulic fracture growth in tight-sandstone-shale Formation: Observation and Modeling.—JOURNAL OF GEOPHYSICAL RESEARCH 2008, 113, B02307) and Shapiro and Dinske (GEOPHYSICAL PROSPECTING, 2009, 57, 301-310doi: 10.1111/j.1365-2478.2008.00770.x) demonstrate that it is possible, in the single fracture case, to determine the fracture propagation from microseismicity data.

The data obtained in these studies is necessarily much cleaner and less noisy than data obtained from a real oilfield HFP run. Because the data is so regular, the researchers were able to fit a relatively detailed fracture model to the data by altering parameters of the model. Once finished, essentially all of their microseismic events are accounted for in a detailed fracture mechanics model.

However this approach cannot be applied to real-world data, such as for multi-well and/or multi-stage hydraulic fracture treatments. This is because real-world data is too noisy and scattered to be able to be explained and encompassed in the described way as it may involve more than one fracture, be noisy, be limited by sensor locations, include other sources of seismic events not directly a result of the leading fracture and/or the like. These factors mean the above approach would result in some data falling outside the model and not being explained. This would then give rise to a greater problem of deciding, which of the microseismic data points were outliers and could be discarded, and no such criterion exists. It therefore does not seem to be possible to fit a fracture mechanics model to real-world data.

Thus, improvements in the area of analyzing real-world microseismic hydraulic fracture propagation events would be highly desirable.

### SUMMARY

One embodiment of the present invention relates to a method of analyzing measured microseismic events obtained from monitoring induced hydraulic fracturing of underground geological formations. In the method, the location of an evolving planar fracture, having a temporal and spatial trajectory, is postulated. The postulated fracture propagation may be determined from knowledge of the material properties of the geology of the formation being fractured, an initiation point of the fracture, at least two measured microseismic events that are consistent with a fracture propagating from the selected initiation point and/or the like. The postulated fracture propagation may be used to assess whether additional measured microseismic events in the microseismic data are sufficiently close to the temporal and spatial trajectory of the postulated fracture propagation to be considered to be occurring as part of the propagation of the fracture. Once the microseismic events associated with the postulated fracture propagation are determined, a statistical analysis may be performed to determine whether the postulated fracture trajectory is statistically significant by comparing the number of microseismic events which are sufficiently close to the postulated fracture with a statistical baseline number. The steps of the method may be repeated as necessary until at least one plausible postulated fracture propagation model is found that is consistent with the measured events is found.

Thus, in some embodiments of the present invention both a spatial and temporal assessment of the microseismic events are utilized and postulated fracture planes/propagations are compared with a statistical baseline. These two developments allow the data to be interrogated involving minimal assumptions regarding the orientation of the fracture planes, and allow only those postulated planes that are statistically significant to be considered further.

Embodiments of the present invention provide for identifying clusters of events whose spatial and temporal separation are consistent with the propagation of a hydraulic fracture according to various standard models of fracture propagation.

In the initial step of postulating the fracture propagation, the fracture propagation model may comprise at least one classical fracture propagation model. Such classical propagation models essentially provide the distance traveled by a fracture as a function of time and require a knowledge of certain physical parameters. There are three principal classical fracture models, pressure-dominated, tip-dominated and radial.

An example of a pressure-dominated model is the Perkins-Kern-Nordgren model (“PKN”) and an example of tip-dominated is Kristonovich-Geertsma-Daneshy model (“KGD”), both being well-known to stimulation/hydraulic fracture engineers in the art of fracture modeling (Schlumberger 2000, Reservoir Stimulation 3^{rd} Edition ISBN-0-471-49192-6). In the models, with pressure dominant, it is assumed that fracture shape and the direction of fracture propagation are specified by principles of fracture mechanics. Both PKN and KGD models have a rectangular extension mode, where the difference between the two models is that PKN model uses an elliptical cross-section, while KGD model has a rectangular cross-section. The radial model has a circular shape and models propagation in a radial direction.

It has been found in practice that a real fracture will progress with a velocity which is within the range of predictions provided by such classical models, and they are therefore extremely useful for providing initial estimates of fracture propagation velocities.

Alternatively, the fracture propagation model may be a pseudo-3D fracture model, which considers all three classical fracture models and considers their relative dominance as the fracture evolves in space and time. Such a model is therefore more detailed and potentially more accurate but is more difficult to implement simply.

The kinds of material properties that the fracture propagation model requires includes Young's Modulus, Poission's ratio, minimum horizontal stress, maximum horizontal stress, pump rate, fracture height and dip of tensile fracture plane.

In some embodiments of the present invention, an assumption is made that at least some of the microseismic data results from fractures at or near the fracture edge as propagation progresses. In embodiments of the present invention, the set of microseismic events that statistically represent a plausible fracture propagation trajectory in time and space are determined.

In an embodiment of the present invention, an initiation point for the postulated fracture is determined. In one embodiment, this may be the first microseismic event (i.e. the microseismic event with the earliest time stamp). Although, other ‘early’ microseismic events may be a potential initiation point, these events may be discounted. if the earlier microseismic events do not correlate with the other measured data, i.e., early events may occur at locations that are removed/isolated in space from the other measured microseismic events

In other aspects, events other than the earliest microseismic event may be used as an initiation point for a postulated fracture particularly where, as in some embodiments of the present invention, the postulating method is used iteratively and other useful knowledge of the formations and geology is known. This iterative processing is discussed further below.

In one embodiment of the present invention, at least two microseismic events other than the initiation-point-microseismic-event are found that fit the postulated trajectory. If no such two microseismic events fit the postulated trajectory then it will be necessary to take a different (possibly later) initiation point and look for two microseismic events that fit a fracture trajectory from that later initiation point.

In one embodiment, once the initiation point is found, two microseismic events may be selected that fit the propagation model of a fracture originating at the initiation point. Fitting the model may comprise the detection time of the microseismic events falling within, which may include allowing for uncertainty in the measured data, a determined fracture propagation velocity, i.e., would the fracture have reached the location of the microseismic events based upon the initiation location and the propagation velocity. In other aspects, directional fracture properties of the formation, formation stress, natural fracture locations and/or the like may be used to select two microseismic events.

Once such at least two microseismic events are found, then a postulated fracture plane/propagation model may be generated. Once a postulated fracture plane is generated, the postulated fracture plane/propagation model may be compared to the other microseismic events in the measured data to assess whether they are sufficiently close to the fracture trajectory, where the fracture trajectory comprises a location, direction and/or time components. Measured data that is sufficiently close to the postulated fracture trajectory may lend weight the postulated fracture plane being a real fracture and those that are not close to the postulated trajectory may lend weight to the postulated fracture plane not representing a real fracture.

Microseismic events are known to have uncertainty in their location. This is because microseismic events rely on detecting sounds which have passed through geological formations. Assumptions are therefore necessary regarding the speed of sound through such geological formations, and this assumption leads to uncertainty. Thus, microseismic events which are ‘sufficiently close’ to the postulated fracture plane are considered as being part of the postulated fracture plane.

One possible definition for ‘sufficiently close’ is to place a maximum distance, e.g. up to 10 meters, up to 5 meters, up to 20 meters and/or the like, for any microseismic event to be considered to be ‘sufficiently close’. However another possibility is that, if it is available, it can be that a microseismic event is not represented by a single point in space but a bounded region of space, representing the uncertainty of the position of the microseismic event. In this case, if the bounded region overlaps with the postulated fracture plane, then it can be considered to be part of the fracture plane.

From the comparison of the postulated fracture propagation with the measured microseismic events, the number of microseismic events which are considered part of the postulated fracture may be compared to a statistical baseline number, to provide a statistical measure of whether the postulated fracture plane represents a real fracture or not.

In one embodiment, the statistical baseline number may be determined by carrying out step of postulating a fracture propagation model (determining an initiation point and finding two consistent microseismic events etc.) and/or the step of comparing the fracture propagation model with the measured microseismic events using the measured microseismic events where the time stamp of each microseismic event is randomized or shuffled. Thus the spatial data may be left untouched but the temporal data for each event may be made random. This has the effect of removing the temporal aspect from the data/randomizing the data.

When the statistical baseline process is carried out using measured microseismic events where the time stamp of each microseismic event is randomized or shuffled a large number of times this produces a number of postulated fracture planes which have resulted from the data without taking into account the time dimension. These postulated fracture planes are however no more than best-fit planes through the time-shuffled data. Nevertheless, such fictional postulated fracture planes will generally fit with a varying number of microseismic events, despite the time shuffling. Thus, the number of microseismic events which fit these time-shuffled fracture planes provides a baseline, below which it can be assumed that the postulated fracture plane is not real, and above which it can be increasingly assumed that the postulated fracture plane is real.

For example, it could be found that the time-shuffled postulated fracture planes were consistent with up to 20 microseismic data points. In that case, when the method of the invention was carried out, a postulated fracture plane consistent with 100 microseismic data points would be a strong candidate for representing a real fracture, whereas one which is consistent with only 30 would be a much weaker candidate for the presence of a real fracture.

In this way this statistical comparison is internally generated by essentially removing the time dimension from the data. It therefore provides a powerful way of identifying the potential presence of real fractures when the time dimension is carried out, and guards against merely finding best-fits to the data which do not represent real fractures.

Additionally, postulated fracture planes could have other criteria applied to them to determine if they are likely to represent real fractures or not. For example, in many regions of hydraulic fracturing it is known that fractures propagate in vertical planes. Therefore any postulated fracture plane which is too far away from vertical may be rejected.

In a refinement of the present invention, after a postulated fracture plane has been identified, the method of the invention can be carried out again from the same initiation point but taking a different pair of measured microseismic events to further assess the initiation point. This can be carried more times, as necessary to analyse a given initiation point.

In another refinement, once an initiation point has been sufficiently analysed, the method of the invention can be carried out on a later initiation point. Thus the invention can be repeatedly carried out for a large number of possible initiation points, assessing each one in turn.

In this way, a large number of postulated fracture planes can be generated. However only those which have a significance in excess of the statistical baseline need to be considered as potential candidates for real fracture planes.

In a further refinement of the invention, the postulated fracture planes with high significance can be employed as geometrical constraints within a complex hydraulic fracture simulation software programme Such software models the evolution of a hydraulic fracture based on a knowledge of the material properties of the geology as well as the actual pump rate of fluid into the fracture. Such software is often termed ‘complex fracture simulation’ in the art and a good example is Mangrove Unconventional Fracture Model (UFM) by Schlumberger. It is a very powerful piece of software, but in view of the scatter in the measured data, as discussed in the introduction, cannot be used alone to fit to the measured data.

Thus, in some embodiments, a method for fracture modelling may include a step wherein at least one postulated fracture plane of high significance relative to the statistical baseline, is compared to the predictions of a complex hydraulic fracture model, to further test the likelihood that it represents a real fracture.

Typically there will be a set of postulated fracture planes with high significance will have different initiation times, suggesting a possible order in which the planes opened. The complex fracture model can be used to test if the possible order of plane opening is consistent.

Furthermore, embodiments of the present invention may include a step wherein the results of the complex fracture modeling are used to help reinterpret the measured seismic data and the steps for postulating a fracture propagation may be repeated again as necessary depending upon consistency of the postulated fracture propagation with the complex fracture modeling.

In one embodiment, the fracture propagation predicted by the complex facture modeling software can replace the classical predictions used in the initial step of postulating a fracture propagation model. In another embodiment, the complex fracture model may suggest a progression with later initiation times. Such later initiation times can be used to test the measured data, or a portion thereof, the further interrogate the data as a whole or in selected portions of time and space.

Thus steps of the methods disclosed herein can be repeated as many times as necessary until a self-consistent interpretation of the measured data is arrived at.

However, even after the above analysis is carried out there may be measured microseismic data or sets thereof which are not explained or modeled by this analysis. This can be for example due to material failure which is not directly as a result of initiated hydraulic fracturing, but is due to other modes of geological material failure.

Thus in one embodiment, the results of the analysis may be used to provide input data into a geomechanical simulation software tool, to predict locations and times of material failure other than that caused by induced hydraulic fracture.

For example, such software can be a finite-element geomechanical simulation tool such as VISAGE by Schlumberger.

Such a geomechanics modeling tool can predict and model material responses to the fluid feed rate and the postulated fractures. This can help to predict and model other forms of material failure other than fracture, which can be responsible for some of the microseismic events not accounted for by the leading fractures.

Finally, in some aspects the steps of the invention are repeated and iterated to refine the location of proposed fracture planes and iterating until the sequence of interpreting the microseismic data, fracture mechanics tool and geomechanics tool are all internally consistent.

### BRIEF DESCRIPTION OF THE DRAWINGS

The present disclosure is described in conjunction with the appended figures. It is emphasized that, in accordance with the standard practice in the industry, various features are not drawn to scale. In fact, the dimensions of the various features may be arbitrarily increased or reduced for clarity of discussion.

FIG. 1 is a chart illustrating pumping of a fluid into an earth formation to produce fracturing therein; and

FIG. 2 is flow-type diagram of a method for monitoring/determining fracture location/propagation in an earth formation, in accordance with an embodiment of the present invention.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention. It being understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments maybe practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

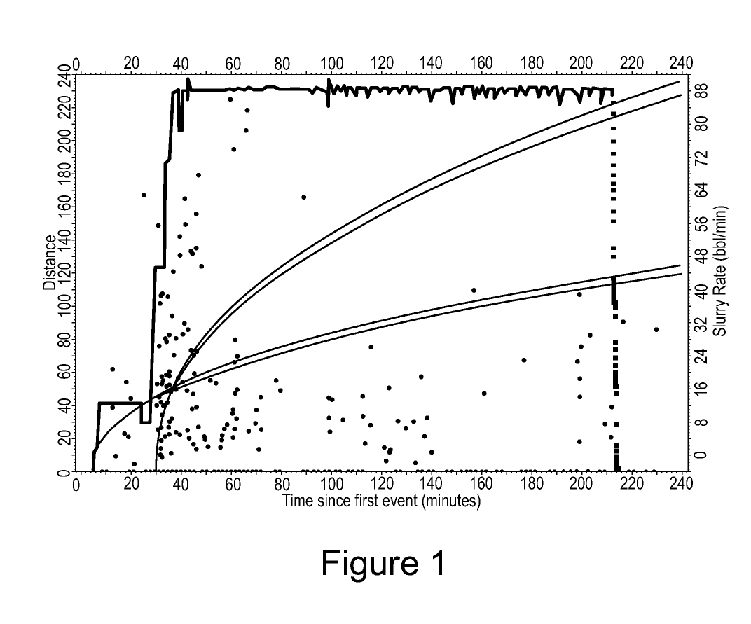

FIG. 1 is a chart showing distance on the left vertical axis and slurry pumping rate on the right vertical axis and time in the horizontal axis. Plotted on the chart is the actual slurry pumping rate, the measured microseismic data and classical model fracture propagation distance-time projections.

In one embodiment of the present invention, once a fracture model has been determined using the methods described above, the microseismic data that falls within the model may be removed from the acquired seismic data. The remaining data may then be analyzed to make a determination about the properties of a subterranean section of the earth. For example, once seismic data related to the propagation of the hydraulic fracture has been removed from the data, it may be possible to identify data associated with “activity” of natural fractures. For example, microseismic data may be obtained that occurred at a location too far away from the propagating fracture and too soon, given the location of the microseismicity. Previously, such data has been discarded. However, in embodiments of the present invention this data may be identified and analyzed to determine properties of natural fractures in the in the subterranean location being fractured. Moreover, in aspects of the present invention, such data may be fed into this and/or other models to determine the effect of hydraulic fracturing on the subterranean location.

### EXAMPLES

The example was carried out on a fifteen-stage hydraulic fracture process across three wells in the Barnett Shale. It has been previously determined that all stages in such a multi-stage situation should be analaysed simultaneously to fully understand the microseismicity. Thus the known methods in the prior art of analysing single isolated fractures in an ideal environment are not capable of being applied in this real-world situation. Only the analysis of the first stage in this complex environment is detailed here.

Fractures in a horizontal well are induced by injection of a fracturing fluid. The resulting fractures in the shale are monitored to detect microseismic events and their space and time is recorded.

Below is presented a method in accordance with one embodiment of the present disclosure to statistically identify clusters of microseismic events whose spatial and temporal separation are consistent with the propagation of a hydraulic fracture, according to various standard models of fracture propagation.

This interpretation is then applied to a forward model of complex fracturing to obtain consistency with the pumping data.

Subsequently the complex fracture model is reviewed via a finite element geomechanical simulation, interpreting via elastic-brittle failure analysis and plastic deformation to understand the potential source of the microseismicity.

The results are that it is possible to obtain a self-consistent interpretation across the various disciplines by this approach.

### Microseismic Data Analysis

In the example method, it is assumed that some microseismic events occur at or near the fracture edge as propagation progresses. It is also assumed that, away from interaction points, the speed at which hydraulic fracture propagates is reasonably approximated by one of the so-called classical models of propagation: the radial crack, pressure dominated (known as PKN), and tip dominated (known as KGD) fracture models that are well known to stimulation engineers.

$$PKN \qquad L = \frac{E ( 1 - 2 υ ) {q}_{i}}{π {h}^{2} ( 1 - {υ}^{2} ) ( {σ}_{H} - {σ}_{h} )} {t}^{\frac{2 n + 2}{2 n + 3 }}$$

$$KGD \qquad L = \frac{E ( 1 - 2 υ ) {q}_{i}}{π {h}^{2} ( 1 - {υ}^{2} ) ( {σ}_{H} - {σ}_{h} )} {t}^{\frac{n + 1}{n + 2 }}$$

$$Radial \qquad R = {( \frac{3 E ( 1 - 2 υ ) {q}_{i}}{16 ( 1 - {υ}^{2} ) ( {σ}_{H} - {σ}_{h} )} )}^{\frac{1}{3}} {t}^{\frac{2 n + 2}{3 n + 6}}$$

As can be seen, these models establish a relationship between distance and time based on knowledge of certain physical. parameters.

Following an induced fracture a large amount of microseismic data is obtained. Furthermore as the data is obtained acoustically through the formation, certain assumptions must be made to determine the time and location of the microseismic event. Persons skilled in the art are aware of this and conventionally microseismic events are represented by a bounded region of possible spatial locations rather than a precise point in space.

1. In the described example, the fracture propagation rates are calculated using the classical models of fracture propagation. Uncertainties in the physical constants used or the difference in horizontal stresses are used to provide a range of potential fracture propagation rates.

2. In the described example, the earliest microseismic event is selected and treated as a fracture initiation point in space and time. In the described example, it is then considered whether this initiation point is consistent with the other microseismic data and the postulated fracture propagation rates established in step 1.

3. In the described example, a pair of events is found, occurring later in time than the initiation point but lying within the fracture propagation distance-time relationship established in step 1. These three microseismic events are used to define a postulated fracture plane.

4. In the described example, each microseismic event is then tested to see if it occurs close enough to the distant-time relationship established in step 1 and is close to the postulated plane established in step 3. If the bounded region of possible locations for a microseismic event overlaps with the time-distance relationship and the postulated plane then it is consistent with the postulated plane.

The sum of all microseismic events consistent with the plane is determined and is called the propagation compatibility of the postulated plane.

5. In the described example, the method goes back to step 3 to identify a further pair of events from the initiation point, and this is repeated until no further pairs of data points are left and the initiation point has been fully analysed.

6. In the described example, the method goes back to step 2 and take another (later) microseismic event and carry out steps 3 to 5 for that microseismic event.

In this way, each microseismic event is systematically checked for it being a potential fracture initiation point and all possible fractures from those points are determined.

The result is a large number of postulated fracture planes, each having a different propagation compatibility value.

### Statistical Baseline

As there is a large amount of data and there is uncertainty in the spatial location of the microseismic events; there may be a large number of postulated fracture planes at this stage. However many of these do not relate to a real fracture and are instead mere artifacts arising from data fitting. It is therefore essential to be able to filter the postulated fracture planes to remove those that are likely not to relate to a real fracture.

In the described example, the statistical baseline is established by carrying out the above analysis on a dataset where the fracture propagation relationship is known not to exist. The results of this will produce postulated fracture planes which are known to be artifacts of data fitting and not to real fractures.

In the described example, the real microseismic data was taken and the temporal-spatial relationship broken by randomly interchanging the event times. The above analysis was then carried out again.

This statistical approach is called ‘bootstrapping’ because it uses the real data to extract the statistical baseline.

In this example, it was found that when the time stamps were interchanged, most fracture planes had a propagation compatibility of 15 to 25. As it is known that none of these postulated fracture planes relate to real fracture planes, this range of values can be taken to be the statistical baseline, above which a postulated fracture plane needs to score to be considered as representing a real fracture. Therefore, in the described example, any postulated fracture plane determined where the time stamp was correct must have a propagation compatibility in excess of this to be considered as being representative of a real fracture.

As noted above, FIG. 1 shows a chart showing distance (left axis) and slurry pumping rate (right axis) versus time. The slurry pumping rate is shown as line 10. Lines 12, 14 represent the maximum and minimum fracture propagation rates respectively based on a PKN classical fracture propagation model. Lines 16, 18 represent the maximum and minimum fracture propagation rates respectively based on a KGD classical fracture propagation model. The plotted data points are the measured microseismic data.

In an ideal scenario the microseismic data consistent with a propagating fracture would be expected to be scattered within a region below the line represented by 12, 14, 16, or 18. This is because lines 12, 14, 16, 18 represent possible forward propagation of the fracture, whereas fractures may occur later in time and behind the fracture tip as it progresses. As can be seen from the data, it is not possible merely to adjust the location of lines 12, 14, 16, 18 until all of the microseismic data falls within the region below the lines. This is because the data is obtained from a real world environment with multiple wells and stages together with sources of microseismic data other than from fracture propagation.

It should be noted that multiple very similar postulated fracture planes may result from this analysis, each representative of one real fracture. This is possible when a real fracture initiation is detected as more than one microseismic event. In this case such very similar planes, even if they all have a high compatibility index, can be considered as a single postulated plane.

It should also be noted that any microseismic event which is too far away from the distance-time projection of the fracture is shown plotted along the time axis 20 to aid clarity. It can be seen that many data points have been rejected in this way.

It should also be noted that there is a large number of microseismic events 22 occurring too early in time to be part of the propagating fracture. However based on past experience it is postulated that these are the result of microseismic activity ahead of the fracture itself but relating to forms of material failure other than fracture propagation. These data points are therefore not rejected because they may be explained by applying a finite element analysis, discussed below.

In addition, there is evidence of the early events 22 occurring to far from the slurry inducing point to be part of fractures originating from the pumped slurry. It is postulated at this point that this is indicative of a later natural fracture propagation.

The preliminary interpretation then is that a pre-existing fracture that can move in response to the initiated fracture propagation and which possibly dilates when the initiated fracture reaches it.

Forward Input into Complex Fracture Model

Once postulated fracture planes with a low propagation compatibility value have been rejected, the result is a series of postulated fracture planes which are statistically significant taking into account both the spatial and temporal measurements of the microseismic data. However further refinement in an interpretation of the data can be obtained by taking these postulated fracture planes and testing them in a complex fracture model.

The software used for the complex fracture simulation is Mangrove Unconventional Fracture Model (mangrove-UFM).

Additionally the location of the postulated pre-existing natural fracture is placed into the geometry for Mangrove-UFM to test.

Into this is placed the postulated fracture planes and the actual slurry pump rate. Rather than utilizing one of the classical models of fracture propagation and an approximated slurry pump rate, Mangrove-UFM uses the actual slurry pump rate and includes a complex fracture propagation model.

This is then used to test the initiation times and locations of the postulated fracture planes to see if they are consistent with Mangrove-UFM.

It is also possible that the Mangrove-UFM will suggest initiation times of fracture occurring later in time, or in particular spatial locations. Such possibilities can then be fed back to the method outlined above to test such possible further initiations.

Thus the complex fracture model feeds back and allows the person skilled in the art further information to allow him to reject or assume further postulated fracture behaviour. Furthermore the microseismic data can be further scrutinized to test such further assumptions until the complex fracture model is consistent with the measured data.

For example, in this case mangrove-UFM suggested that the induced fracture meets a pre-existing fracture plane in the rock formation. Furthermore, the Mangrove-UFM simulation suggests that the fracture progress downwards once it hits the pre-existing natural fracture. This is something that could not have been predicted with the microseismic data and classical fracture equations alone.

The resulting interpretation thus shows to be consistent with the above postulation that there is a pre-existing natural fracture which dilates when the induced fracture reaches it.

The original data can now be examined again to test for a new initiation point triggering this downgrowth, and indeed the data support this interpretation.

Such consistency lends further weight to a postulated sequence of fracture events by the skilled person.

### Finite Element Geomechanics

As a further refinement, it is possible to test the output of the above analysis for consistency with a finite element geomechanics model.

The induced fractures are modeled as pressure-filled slots. The initial radial fractures and the subsequent downgrowth are separate steps in a dynamic simulation. It was found that plastic strain on the natural fracture may be interpreted as a candidate explanation of the micrseismicity of that feature.

Elastic-brittle zones analysis gives zones of potential failure that correspond spatially to the observed microseismicity.

The method according to embodiments of the present invention statistically extracts fracture planes from the microseismic events by considering the spatio-temporal propagation of fractures via classical fracture models. The geometries recovered in this way are tested against a statistical baseline which are constructed by breaking the temporal aspect of the data-set.

Such geometries do not provide immediate inversion of the complex fracture system, but are used to construct a chronological and geometric description of the complex fracturing that is then tested using a complex fracture simulator to understand the material balance issues.

The complex fracture simulation results are applied back to the original data-set to reinterpret them and forward to a geomechanical simulation which is used to derive failure estimates which are compared to the measured microseismicity.

This approach can yield self-consistent interpretations of multi-stage, multi-well treatments.

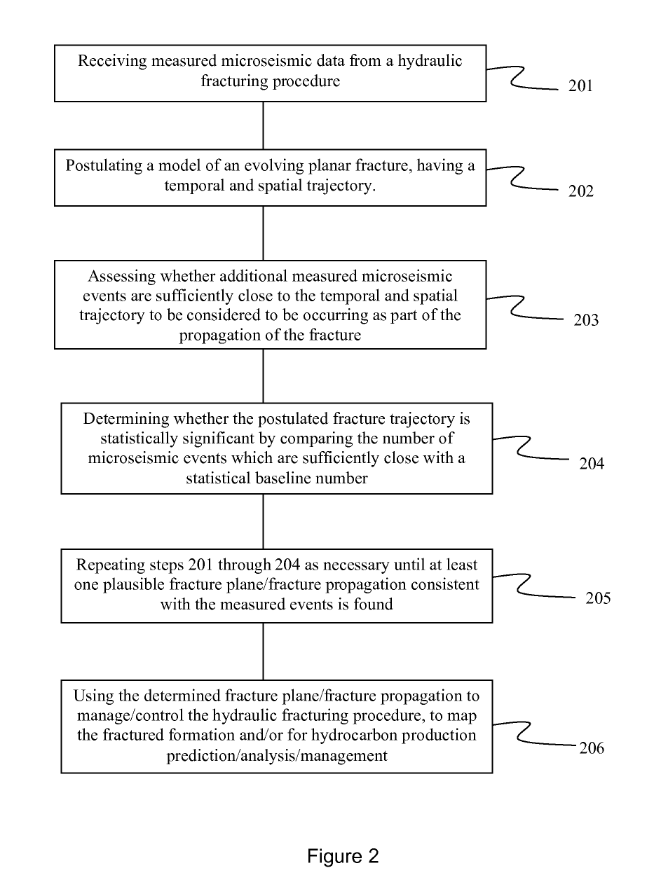

FIG. 2 illustrates a method for monitoring/determining a location/propagation of a fracture produced by a hydraulic fracturing procedure, in accordance with an embodiment of the present invention.

In an embodiment of the present disclosure, measured microseismic data is received from a hydraulic fracturing procedure. The data may comprise recorded or real-time measurements of microseismic data produced by the hydraulic fracturing procedure.

In an embodiment of the present disclosure, a model of a fracture trajectory is postulated using the received microseismic data. The fracture trajectory model has both spatial and temporal components that describe the propagation of the fracture through the earth formation in which fractures are being induced in the hydraulic fracturing process. The fracture trajectory model is postulated using knowledge of the material properties of the geology of the earth formation, an initiation point for the fracture and at least two measured microseismic events that are consistent with the postulated fracture trajectory.

The knowledge of the material properties of the geology of the earth formation may be used to determine potential directions of fractures, i.e., mechanics of the formation, stresses, natural fractures and/or the like may provide fracture direction probabilities or the like. The knowledge of the material properties of the geology of the earth formation and/or knowledge of the hydraulic fracturing procedure may be used to determine fracture propagation velocity or the like.

The fracture initiation point may be one of the earliest microseismic events in the data that is consistent with the remaining data, or may be a point in the data that is determined from iterating the data to determine when fracture development originated. Once an initiation point is selected, two other microseismic events may be selected where the temporal and spatial separation of the two selected microseismic events with respect the the initiation point are consistent with a fracture propagation model, i.e. are consistent with a propagation velocity for the fracture, consistent with a fracture direction of the fracture, consistent with natural fractures in the formation and/or the like. In some aspects the fracture velocity may be determined from knowledge about the geology, the pressure of the fluid being pumped in the hydraulic fracturing procedure and/or the like. Using the fracture velocity, the two points may be found that are consistent, based upon their time stamp, and the location/time of the initiating point, with propagation of a fracture from the initiation point. In certain aspects, other properties of the earth formation may be used with propagation velocity to determine whether microseismic events are consistent with fracture propagation from the initiation point. In some aspects, the initiation point and the two or more selected seismic events may be determined in real-time.

In an embodiment of the present disclosure, the model of the fracture trajectory, as determined above, is used to analyze the microseismic data to assess whether additional measured microseismic events are sufficiently close to the temporal and spatial trajectory of the fracture trajectory model. In certain aspects, uncertainty in the spatial and/or temporal locations of the microseismic events is taken into account in the in the analysis. In other aspects, microseismic events that fall within a temporal and/or special threshold of the fracture trajectory model are considered sufficiently close to the fracture trajectory model.

In an embodiment of the present disclosure, once the number of microseismic events in the microseismic data that are consistent with the fracture trajectory model are determined, the number of consistent microseismic events is analyzed to determine whether the number is statistically significant or the like. In one aspect, significance is determined by randomizing the timing of the microseismic events in the microseismic data, determining a model of a fracture trajectory for the randomized data and finding the number of consistent microseismic events in the microseismic data that are consistent with the randomized fracture trajectory model; this random value is then compared to the non-randomized value. In other aspects, the model of the fracture trajectory is analyzed with randomized microseismic events, i.e., the microseismic events in the microseismic data which has been randomized by assigning random event times to the events, and the consistency with the randomized microseismic data is compared to consistency with the actual microseismic data to determine significance.

The steps of the method, as provided above, may be repeated as necessary until at least one plausible fracture plane consistent with the measured events is found.

In an embodiment of the present disclosure, the determined fracture plane/fracture propagation may be used to manage/control the hydraulic fracturing procedure, to map the fractured formation and/or for hydrocarbon production prediction/analysis/management. For example, the hydraulic fracture procedure may be controlled in real-time, fluid pump rate, fracture placement etc., depending on the fracture [properties determined by the present method. Additionally, the determined fracture plane/fracture propagation may be added to a reservoir model and used for determining further fracture placement procedures, analyzing potential hydrocarbon production, managing the hydrocarbon reservoir and/or the like. It may be very important to control the hydraulic fracturing procedure to ensure correct placement of stimulated fractures and/or record the placement of such fractures.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the scope of the present disclosure, and that they may make various changes, substitutions and alterations herein without departing from the scope of the present disclosure. More specifically, unless incompatible, embodiments described herein and/or features of such embodiments may be combined with other embodiments described herein and/or features of such other embodiments.

The Abstract at the end of this disclosure is provided to comply with 37 C.F.R. §1.72(b) to allow the reader to quickly ascertain the nature of the technical disclosure. It is submitted with the understanding that it will not be used to interpret or limit the scope or meaning of the claims.

1. A method of analyzing measured microseismic events obtained from monitoring induced hydraulic fracturing of underground geological formations, the method involving
(a) postulating the location of an evolving planar fracture, having a temporal and spatial trajectory based on a fracture propagation model requiring knowledge of the material properties of the geology, an initiation point and at least two measured microseismic events that fit the postulated fracture trajectory;
(b) assessing whether additional measured microseismic events are sufficiently close to the temporal and spatial trajectory to be considered to be occurring as part of the propagation of the fracture;
(c) determining whether the postulated fracture trajectory is statistically significant by comparing the number of microseismic events which are sufficiently close with a statistical baseline number;
(d) repeating steps (a) to (c) as necessary until at least one plausible fracture plane consistent with the measured events is found.

2. A method according to claim 1, wherein, in step (a), the fracture propagation model is at least one classical fracture propagation model.

3. A method according to claim 1 wherein, in step (a), the fracture model is a pseudo-3D fracture model.

4. A method according to claim 1 wherein, in step (a), the material properties are selected from the list consisting of Young's Modulus, Poission's ratio, minimum horizontal stress, maximum horizontal stress, pump rate, fracture height and dip of tensile fracture plane.

5. A method according to claim 1 wherein, in step (a), the initiation point is the first microseismic event.

6. A method according to claim 5, wherein if no such two microseismic events fit the postulated trajectory then a later microseismic event is chosen as the initiation point and look for two microseismic events that fit a fracture trajectory from that later initiation point.

7. A method according to claim 1, wherein, in step (b), a microseismic event is considered to be sufficiently close if it is within 10 m of the postulated fracture plane.

8. A method according to claim 1 wherein, in step (b), a microseismic event is considered to be sufficiently close if the bounded region of its probable location overlaps the fracture plane.

9. A method according to claim 1 wherein, in step (c), the statistical baseline number is determined by carrying out steps (a) and (b) of the invention but with the time stamp of each microseismic event randomized or shuffled.

10. A method according to claim 1, wherein after a postulated fracture plane has been identified, the method of the invention can be carried out again from the same initiation point but taking a different pair of measured microseismic events to further assess the initiation point.

11. A method according to claim 1, wherein once an initiation point has been sufficiently analysed, the method of the invention is carried out on a later initiation point.

12. A method according to claim 1, wherein the postulated fracture planes with high significance are employed as geometrical constraints within a complex hydraulic fracture simulation software programme.

13. A method according to claim 12, which includes a step (d) wherein at least one postulated fracture plane of high significance relative to the statistical baseline, is compared to the predictions of a complex hydraulic fracture model, to further test the likelihood that it represents a real fracture.

14. A method according to claim 12, wherein the complex fracture model is used to test if the time ordering of plane propagation is consistent with the complex models predictions.

15. A method according to claim 12, which includes a step (e) wherein the results of the complex fracture modeling are used to reinterpret the measured microseismic data and steps (a) to (c) are repeated again as necessary.

16. A method according to claim 15, wherein the fracture propagation predicted by the complex fracture modeling software replaces the classical predictions used in step (a) during the first iteration.

17. A method according to claim 15, wherein steps (a) to (c) are repeated again as necessary based on an initiation point resulting from the predictions of the complex fracture model.

18. A method according to claim 15, wherein steps (a) to (f) are repeated as many times as necessary until a self-consistent interpretation of the measured data is arrived at.

19. A method according to claim 1, wherein the results of the analysis are used to provide input data into a geomomechanical simulation software tool, to predict locations and types of material failure other than that caused by fracture.

20. A method according to claim 15, wherein the steps of the invention are repeated and iterated to refine the location of proposed fracture planes and iterating until the sequence of interpreting the microseismic data, fracture mechanics tool and geomechanics tool are all internally consistent.
